(19) United States
(12) Patent Application Publication
(10) Pub. No.: US 2023/0251049 A1
(43) Pub. Date: Aug. 10, 2023

(54) PLASTIC RECEIVER WITH A REMOVABLE CARRIER TUBE

(71) Applicant: Abdullah Oguz Tasyagan

(72) Inventor: Abdullah Oguz Tasyagan

(21) Appl. No.: 18/250,527

(22) PCT Filed: Apr. 29, 2020
(86) PCT No.: PCT/TR2020/051428

§ 371 Date: Apr. 25, 2023

(51) Int. Cl. F41A 3/66; F41A 3/84

(52) U.S. Cl. CPC F41A 3/66; F41A 3/84

(57) ABSTRACT

The invention is related to the removable connection of the carrier tube (1) and the components on it to the plastic receiver (7) by means of the fixing nut (2) in a combination of a carrier tube (1) and plastic receiver (7). It is related to positioning of recoil spring inside the carrier tube (1) and the plastic receiver (7) made of plastic material in which more than one stock with different types and features can be located on the same carrier tube.

### TECHNICAL FIELD

The invention is related to the removable connection of the carrier tube and the components on it to the plastic receiver by means of the fixing nut in a combination of a carrier tube and plastic receiver. It is related to positioning of recoil spring inside the carrier tube and the plastic receiver made of plastic material in which more than one stock with different types and features can be located on the same carrier tube.

### PRIOR ART

In the state of the art, there are more than one method in which the carrier tube is connected to the rifle receiver.

In the first of these, in a metal or metal alloy receiver, the carrier tube is connected to the receiver by directly threading on and passing the receiver.

Again, in the state of the art, there are also receivers made of non-metal (plastic etc.) materials. Screw bushes are placed into these receivers in an unremovable manner. This way the receiver and carrier tube are passed on this bush.

Problems occur in both of the aforementioned present techniques. As a result of the prolonged use of the rifle, problems such as the deterioration of the connection threads and the self-dislocation of the carrier tube are experienced. In this case, the entire receiver is subject to renewal. This, in return, creates extra costs.

In the present technique, rifles with a fixed structure and carrier tube do not allow the extension or shortening of the stock according to the physical characteristics of the user.

### PURPOSE OF THE INVENTION

The main purpose of the invention is to have a structure in which the plastic receiver and carrier tube can be disassembled and assembled when necessary, which is developed to eliminate all the problems in the state of the art. In the plastic receiver structure subject to the present invention, the fixing nut to which the carrier tube is fixed, is placed on the receiver later and in a removable manner. In order to solve the problem of self-dislocation of the carrier tube as a result of prolonged use of the rifle, it is sufficient to change the fixing nut only. This method eliminates the burden and extra cost of the complete renewal of the rifle receiver and this is the solution in the present technique. In addition to the cost advantage, with the use of the plastic receiver and carrier tube in firearms, which are passed with the fixing nut, it provides many advantages over its counterparts.

In addition, a resistance bush is used in order to prevent the deformation of the plastic receiver as a result of the impacts. The plastic receiver is manufactured by pressing plastic into it with injection or casting method together with the resistance bush placed in the mold. Thus, the plastic receiver also has a stronger structure.

The recoil spring and other auxiliary components are also placed in the carrier tube, which is passed into the plastic receiver with a fixing bush. The carrier tube is designed in such a way that it accommodates the recoil spring in it, as well as allowing the long stocks to be mounted on it. In this way, the recoil spring is positioned inside the long stock. Depending on the user’s request, either a telescopic or a fixed stock can be easily mounted on the carrier tube. This feature provides superiority to the plastic receiver.

### DETAILED DESCRIPTION OF THE INVENTION

The plastic receiver that is passed by means of the fixing nut of the carrier tube made in order to achieve the purpose of this invention is shown in the attached figures.

These figures are;

FIG. 1 Assembly view of the carrier tube and the plastic receiver

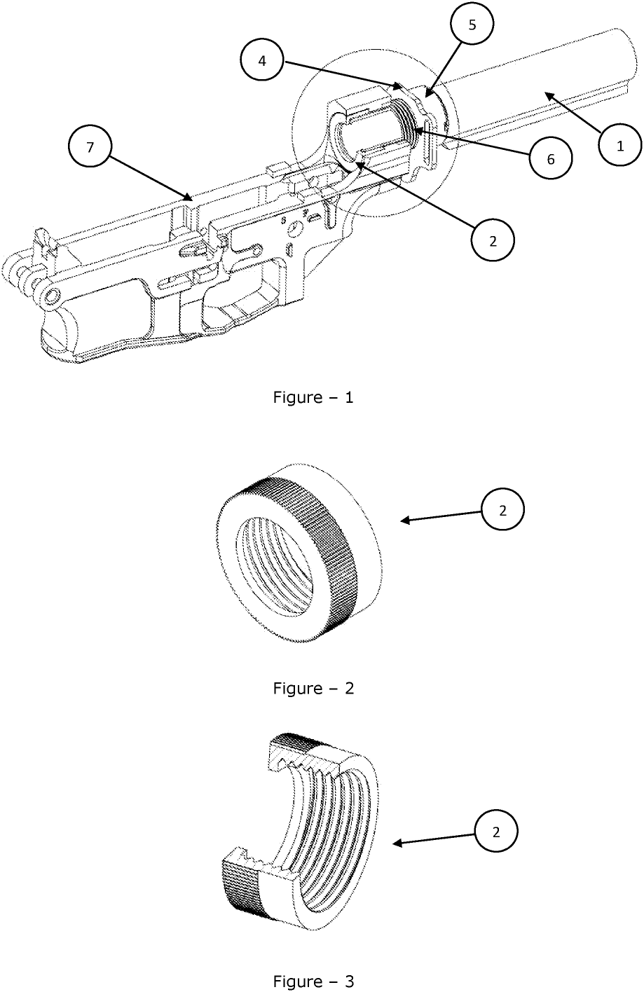

FIG. 2 Perspective view of the fixing bush

FIG. 3 Sectional view of the fixing bush

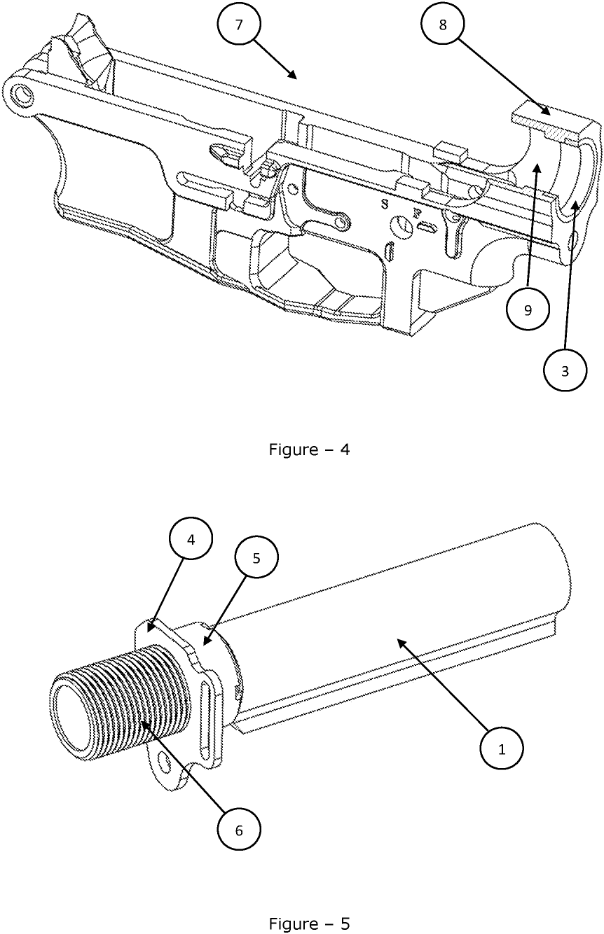

FIG. 4 Perspective view of the plastic receiver

FIG. 5 Perspective view of the carrier tube

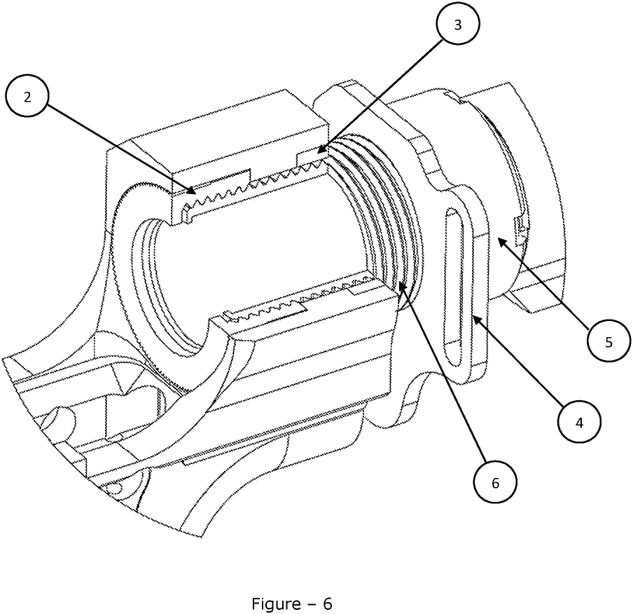

FIG. 6 Detailed assembly view of the carrier tube and the plastic receiver

Numbers are placed on the pictures in order to better understand the combination of plastic receiver and carrier tube fixed by means of the fixing nut subject to the invention. Accordingly;
1. Carrier tube
2. Fixing nut
3. Resistance bush
4. Sling holder
5. Sling holder fixing nut
6. Thread
7. Plastic receiver
8. Mounting channel
9. Nut groove

As shown in FIG. 1, the subject of the invention, the carrier tube (1) is fixed to the plastic receiver (7) by means of the fixing nut (2). The fixing nut (2) allows the plastic receiver (7) and the carrier tube (1) to be detached from each other when required. The carrier tube (1) shown in FIG. 5 is produced from an aluminum and/or aluminum-derived material. There are threads (6) on at least one end of the carrier tube (1) shown in FIG. 5. Sling holder fixing nut (5) and sling holder (4) are positioned on the carrier tube (1), respectively.

During the production, firstly the sling holder fixing nut (5) is fully tightened to the threads (7) that are at one end of the carrier tube (1). Then the sling holder (4) is mounted. The sling holder (4) is tightened until it rests on the sling holder fixing nut (5). Then, the resistance bush (3) is passed through the carrier tube (1). However, the inner surface of the resistance bush (3) is smooth; that is, it cannot be fixed on the threads (7) since it is not grooved. The resistance bush (3) is produced from a metal and/or metal-derived material.

The plastic receiver (7) shown in FIG. 4 is produced by pressing plastic into a mold via injection or casting method. During production, the threads (6) of the carrier tube (7) are passed through the mounting channel (8) formed on the plastic receiver (7). The inner surface of the mounting channel (8) formed in the plastic receiver (7) is smooth; that is, it has a smooth structure. The resistance bush (3) on the threads (6) of the carrier tube (1) connected to the mounting channel (8) contacts with the mounting channel (8). This way, the resistance bush (3) increases the strength of the plastic receiver (7) it is in contact with. However, since the resistance bush (3) cannot be fixed to the threads (6), it cannot fix the plastic receiver (7) to the carrier tube (1).

In order to fix the carrier tube (1) to the plastic receiver (7), it is tightened by turning the fixing nut (2) on the carrier tube (1) and from the part of the carrier tube (1) which is inside the plastic receiver (7). The fixing nut (2) is positioned in the nut groove (9) that is inside the mounting channel (8). It is possible to form the nut groove (9) during the production of the plastic receiver (7). The nut groove (9) can optionally be formed after the plastic receiver (7) is produced.

The fixing nut (2) shown in FIG. 2 is optionally produced from metal and/or metal-derived material. The fixing nut (2) is fastened and mounted on the threads (6) by means of the grooved structure on its inner surface. In addition, a part of the upper surface of the fixing nut (2) is produced in rough form. The surface area of the fixing nut (2) increases thanks to its rough surface. Thus, the traction of the fixing nut (2) in the nut groove (9) increases. The grooved structure of the inner surface and the rough structure of the outer surface of the fixing nut (2) shown in FIG. 3 ensure the fixation of the plastic receiver (7) and the carrier tube (1). Depending on the use of the rifle, the fixing nut (2) can be disassembled as a result of the carrier tube (1) coming out of the plastic receiver (7) automatically. The technical problem is solved by replacing the removed fixing nut (2) with a new fixing nut (2).

After fixing the carrier tube (1) and the plastic receiver (7), at least two threads (6) remain free between the plastic receiver (7) and the sling holder (4). Then the sling holder fixing nut (5) is turned towards the plastic receiver (7). Thus, the sling holder (4) moves towards the plastic receiver (7). This motion continues until the sling holder (4) rests to the plastic receiver (7). There are no free threads (6) left between the plastic receiver (7) and the sling holder (4) which abut each other by means of the sling holder fixing nut (5).

The recoil spring is positioned on the inner surface of the carrier tube (1). This way, it becomes possible to attach different types of stocks on the same carrier tube (1).

1. The combination of plastic receiver (7) and carrier tube (1) in the firearms, which are produced by plastic injection or casting method, comprising;
a. at least one carrier tube (1) passed through the mounting channel (8) formed on the plastic receiver (7);
b. at least one fixing nut (2) which is tightened by turning through the end of the said carrier tube (1) which is inside the said plastic receiver (7).

2. The combination of plastic receiver (7) and carrier tube (1) in accordance with claim 1, characterized in that; the fixing nut (2) is made of metal and/or metal-derived material.

3. The combination of plastic receiver (7) and carrier tube (1) in accordance with claim 1, characterized in that; the inner surface of the fixing nut (2) is grooved.

4. The combination of plastic receiver (7) and carrier tube (1) in accordance with claim 1, characterized in that; a part of the outer surface of the fixing nut (2) is rough.

5. The combination of plastic receiver (7) and carrier tube (1) in accordance with claim 1, characterized in that; there is at least one nut groove (9) inside the mounting channel (8) on the said plastic receiver (7) that can be formed during the production of the said plastic receiver (7) or after the said plastic receiver (7) is produced.

6. The combination of plastic receiver (7) and carrier tube (1) in accordance with claim 1, characterized in that; the inner surface of the mounting channel (8) formed on the said plastic receiver (7) is smooth.

7. The combination of plastic receiver (7) and carrier tube (1) in accordance with claim 1, comprises; at least one resistance bush (3) that contacts the mounting channel (8) formed on the said plastic receiver (7) by passing through the threads (6) of the said carrier tube (1).

8. The combination of plastic receiver (7) and carrier tube (1) in accordance with claim 1, characterized in that; the inner surface of the resistance bush (3) in the said plastic receiver (7) is smooth.

9. The combination of plastic receiver (7) and carrier tube (1) in accordance with claim 1, characterized in that; the resistance bush (3) in the said plastic receiver (7) is made of metal and/or metal-derived material.

10. The combination of plastic receiver (7) and carrier tube (1) in accordance with claim 1, characterized in that; said carrier tube (1) is made of aluminum and/or an aluminum-derived material.

11. The combination of plastic receiver (7) and carrier tube (1) in accordance with claim 1, characterized in that; said carrier tube (1) has at least one thread (6) on at least one end.

12. The combination of plastic receiver (7) and carrier tube (1) in accordance with claim 1, characterized in that; there are at least two threads (6) that remain free between the said plastic receiver (7) and the sling holder (3) after the fixation of the said plastic receiver (7) and said carrier tube (1) with the fixing nut (2).
